(19) United States
(12) Patent Application Publication
(10) Pub. No.: US 2026/0167578 A1
(43) Pub. Date: Jun. 18, 2026

(54) METHOD FOR MULTI-PHASE PREPARATION OF COMPLEX MINERAL FERTILIZER FROM PHOSPHATE ROCK AND NITRIC ACID

(71) Applicant: SABIC AGRI-NUTRIENTS COMPANY, Riyadh (SA)

(72) Inventors: Mohamed AL-RABHI, Riyadh (SA); Aghaddin Khanlar MAMEDOV, Riyadh (SA)

(73) Assignee: SABIC AGRI-NUTRIENTS COMPANY, Riyadh (SA)

(21) Appl. No.: 19/129,438

(22) PCT Filed: Nov. 14, 2023
(86) PCT No.: PCT/IB2023/061496

§ 371 Date: May 13, 2025

Related U.S. Application Data
(60) Provisional application No. 63/425,088, filed on Nov. 14, 2022.

(51) Int. Cl. C05B 7/00; C05C 3/00; C05C 5/04; C05D 3/02; C05G 5/12; C05G 5/18; C05G 5/35

(52) U.S. Cl. CPC C05B 7/00; C05C 3/00; C05C 5/04; C05D 3/02; C05G 5/12; C05G 5/18; C05G 5/35

(57) ABSTRACT

Disclosed is a fertilizer containing a mixture containing calcium ammonium phosphate (CaNH₄PO₄), calcium nitrate (Ca(NO₃)₂), and ammonium sulfate ((NH₄)₂SO₄). Methods of making and using the fertilizer are also disclosed.

### CROSS-REFERENCE TO RELATED APPLICATIONS

This application claims priority to and the benefit of U.S. Provisional Application No. 63/425,088, filed Nov. 14, 2022, the contents of which is incorporated into the present application by reference in its entirety.

### BACKGROUND OF THE INVENTION

### I. Field of the Disclosure

This disclosure generally concerns fertilizer compositions containing a slow-release agent. In particular embodiments, the disclosure concerns fertilizers containing calcium ammonium phosphate, ammonium sulfate, and calcium nitrate.

### II. Background

Soil nutrients, such as nitrogen, phosphorus, potassium, and sulfur, as well as trace elements such as iron, zinc, copper, calcium, and magnesium, are useful for achieving thriving agriculture and growth of plants. Upon repeated planting cycles, the quantity of these nutrients in the soil may be depleted, resulting in inhibited plant growth and decreased production. To counter this effect, fertilizers have been developed to help replace the depleted vital nutrients. Single-nutrient fertilizers and multi-nutrient fertilizers, such as fertilizer blends, have been developed to meet the varied needs of crop production worldwide.

Application of a fertilizer does not always provide the full amount of the nutrients in the fertilizer to the plant within a short period of time. Some fertilizers contain nutrient containing compounds that are not readily available to the plant upon application. In these circumstances, some apply fertilizer well before the planting of plants, or some over fertilize closer to the planting of the plants to provide sufficient nutrients to the plant initially. However, this comes at the cost of time, may require multiple treatments to the soil before or after planting, and/or may increase expenses.

Plants, such as crop plants, need nutrients at least over the entire growth and maturation period for the plant. However, many fertilizers, when applied to a soil, disperse, are degraded, or are taken up within a short period of time after application. To address this issue, fertilizers can be applied multiple times to the same plants or slow release fertilizers can be used. Some approaches to slow release fertilizers include polymer coating a fertilizer core. However, many polymer coatings are expensive and/or will undesirably build up in the soil over time after repeated applications. Some approaches to slow the release of fertilizers include coating or mixing with insoluble metal oxides, such as MgO and CaO. However, these metal oxides do not provide much, if any, nutrients to the plant.

### SUMMARY OF THE INVENTION

A solution to at least some of the problems discussed above is disclosed herein, including generating a fertilizer product without requiring urea, though urea may also be used in addition, and generating a fertilizer product that has slow-release characteristics for its nutrients. In some aspects, the component(s) build up in soil as a reservoir of nutrients for release over a time. In one aspect, the solution resides in providing a fertilizer comprising calcium (Ca), nitrogen (N) present as ammonium and nitrate, sulfur(S) present as sulfate, and phosphorus (P) present as phosphate. In some aspects, the fertilizer contains calcium ammonium phosphate, ammonium sulfate, and calcium nitrate. The calcium ammonium phosphate may act as a binder for the other components in the fertilizer, such as the ammonium sulfate and calcium nitrate. In some embodiments, synthesis of at least part of the fertilizer occurs through reacting a metal phosphate with nitric acid. Non-limiting example reactions can include the following:

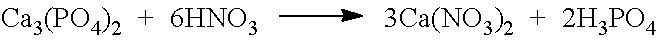

In some embodiments, synthesis of at least part of the fertilizer occurs through reacting a phosphoric acid and an ammonia source, such as ammonium hydroxide (NH₄OH) and/or ammonia gas, to produce ammonium phosphate. Non-limiting example reactions can include the following:

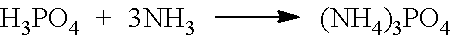

In some embodiments, synthesis of at least part of the fertilizer occurs through reacting a metal nitrate, such as calcium nitrate, and ammonium phosphate, to produce a metal ammonium phosphate, such as calcium ammonium phosphate, and ammonium nitrate. Non-limiting example reactions can include the following:

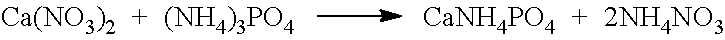

In some embodiments, synthesis of at least part of the fertilizer occurs through reacting a metal sulfuric compound, such as CaSO₄, and ammonium nitrate, to produce a metal nitrate, such as calcium nitrate (Ca(NO₃)₂), and ammonium sulfate ((NH₄)₂SO₄). Non-limiting example reactions can include the following:

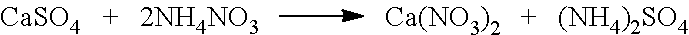

The final product may contain a mixture of the above composition chemicals, including, but not limited to any one of CaNH₄PO₄, Ca(NO₃)₂, and (NH₄)₂ (SO₄).

In some aspects, the reactions are performed in one or more than one container. In some aspects, the reactions are performed simultaneously or sequentially or a mixture of both.

Embodiments of the disclosure are improvements to known fertilizer, including by involving the use of a slow-release agent in a fertilizer comprising nitrogen (N), phosphorus (P), sulfur(S), and a metal such as calcium (Ca). Current slow-release fertilizer products often use physical intervention to slow the release of the fertilizer, such as by coating the fertilizer with a polymer insoluble material to slow the fertilizer's release. Current slow-release fertilizers may also employ enzymatic inhibitors, such as urease inhibitors or nitrification inhibitors, to slow the utilization of the fertilizer. Though the fertilizers described herein may also contain physical interventions and/or inhibitors, the fertilizers described herein do not always require such measures to produce a slow-release nutrient fertilizer composition.

Embodiments herein describe mixtures of nutrients, and the preparation of such mixtures, which play a role for generating a buildup of fertilizer in soil as reservoir of nutrients for release over time. The fertilizer can include an immediate-release aspect of the fertilizer that can comprise or consist of soluble reactants or products of the reactions described herein and any combination thereof. The slow-release aspect of the fertilizer can comprise or consist of one or more double salts, such as calcium ammonium phosphate.

In some aspects, the fertilizer comprises or consists of calcium ammonium phosphate, calcium nitrate, and ammonium sulfate.

Fertilizers encompassed in certain embodiments herein comprise ingredients that can be used to cover immediate soil Ca, N, and S deficiency in the form of an easily soluble calcium sulfate, calcium nitrate, and/or ammonium sulfate, while also covering long-term Ca, N, and P needs through a slow release of CaNH₄PO₄.

Certain aspects are directed to a fertilizer comprising a homogenous mixture comprising a nitrogen source, a phosphorus source, a sulfur source, and a calcium source. The homogenous mixture, in some aspects, comprises a binder. The binder can comprise a slow-release agent. The slow-release agent can comprise calcium ammonium phosphate (CaNH₄PO₄). The homogenous mixture, in some aspects, comprises an immediate-release agent. The immediate-release agent can comprise ammonium sulfate, calcium nitrate, and optionally calcium sulfate.

Certain aspects are directed to a fertilizer comprising at least a portion of the immediate-release agents encapsulated by the calcium ammonium phosphate. Certain aspects are directed to a fertilizer comprising at least a portion of the immediate-release agents contained on the surface of the calcium ammonium phosphate. Certain aspects are directed to a fertilizer comprising at least a portion of the immediate-release agents contained in a dried gel of calcium ammonium phosphate.

In some aspects, the fertilizer does not comprise a binding agent separate from the calcium ammonium phosphate (CaNH₄PO₄). The fertilizer can be a granular fertilizer.

In certain aspects, the fertilizer contains at least any one of, at most any one of, equal to any one of, or between any two of 10, 11, 12, 13, 14, 15, 16, 17, 18, 19, or 20 wt. % nitrogen (N), at least any one of, at most any one of, equal to any one of, or between any two of 11, 12, 13, 14, 15, 16, 17, 18, 19, or 20 wt. % phosphorous (P) in an amount equivalent to P₂O₅, at least any one of, at most any one of, equal to any one of, or between any two of 4, 5, 6, 7, 8, 9, 10, or 11 wt. % sulfur(S), and/or 12, 13, 14, 15, 16, 17, 18, 19, or 20 wt. % calcium (Ca). In some instances, the immediate-release agent and the slow-release agent are comprised at a weight ratio between approximately 5:1 to 1:5, such as 5:1, 4:1, 3:1, 2:1, 1:1, 1:2, 1:3, 1:4, or 1:5.

In certain aspects, the fertilizer does not contain urea and/or a polymer. In certain aspects, the fertilizer further comprises urea and/or a polymer.

In certain aspects, the calcium phosphate is sourced from or is comprised in calcium phosphate rock. In certain aspects, the calcium sulfate is gypsum. In certain aspects, the gypsum is and/or is sourced from or is comprised in red gypsum or waste gypsum.

Certain aspects are directed to a method of making a fertilizer, including any fertilizer described herein. The method can include steps (a) and/or (b). In step (a), a metal phosphate is reacted with nitric acid and an ammonia source to generate a first reaction product comprising a metal ammonium phosphate and ammonium nitrate. In some instances, step (a) comprises contacting the metal phosphate with nitric acid to generate an initial reaction product comprising a metal nitrate and phosphoric acid and contacting the initial reaction product with a source of ammonia to generate the first reaction product. In step (b), the first reaction product can be contacted with a metal sulfate to generate a second reaction product comprising a metal nitrate and ammonium sulfate and also comprising the metal ammonium phosphate from step (a). In certain aspects, the method of making the fertilizer comprises drying the fertilizer mixture to form a solid fertilizer composition. Steps (a) and (b) and/or drying may occur at approximately 20° C. to 150° C., such as 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, and 150° C. In some aspects, steps (a) and/or (b) may occur at 20 to 75° C. or any temperature or range therein. In some aspects, the fertilizer composition comprises or consists of: calcium ammonium phosphate, calcium nitrate, ammonium sulfate, phosphoric acid, ammonium phosphate, ammonium hydroxide, ammonium nitrate, calcium sulfate, a calcium phosphate, nitric acid, and/or ammonia. In some aspects, the ammonia source comprises a solution of ammonium hydroxide, ammonium, ammonium carbonate, ammonia gas, succinimide, and/or phthalimide.

Also disclosed are the following aspects 1 to 20 of the present invention.

Aspect 1 is a fertilizer composition comprising calcium ammonium phosphate (CaNH₄PO₄), calcium nitrate (Ca(NO₃)₂), and ammonium sulfate ((NH₄)₂SO₄).

Aspect 2 is the fertilizer composition of aspect 1, wherein the composition comprises 12 to 19 wt. % nitrogen (N), phosphorous (P) in an amount equivalent to 12 to 19 wt. % P₂O₅, 14 to 20 wt. % calcium (Ca), and 5 to 10 wt. % sulfur(S).

Aspect 3 is the fertilizer composition of any one of aspects 1 and 2, wherein the composition further comprises phosphoric acid (H₃PO₄), ammonium phosphate ((NH₄)₃PO₄), ammonium hydroxide (NH₄OH), and/or ammonium nitrate (NH₄NO₃).

Aspect 4 is the fertilizer composition of any one of aspects 1 to 3, wherein the composition further comprises calcium sulfate (CaSO₄), a calcium phosphate (Ca₃(PO₄)₂), nitric acid (HNO₃), and/or ammonia (NH₃).

Aspect 5 is the fertilizer composition of aspect 4, wherein the composition comprises calcium sulfate comprised in waste gypsum and/or a recycled gypsum.

Aspect 6 is the fertilizer composition of any one of aspects 1 to 5, wherein the composition does not comprise a binding agent separate from the calcium ammonium phosphate.

Aspect 7 is the fertilizer composition of any one of aspects 1 to 6, wherein at least a portion of the ammonium sulfate and/or calcium nitrate is absorbed on the surface of the calcium ammonium phosphate.

Aspect 8 is the fertilizer composition of any one of aspects 1 to 7, wherein the fertilizer composition further comprises a potassium source.

Aspect 9 is the fertilizer composition of any one of aspects 1 to 8, wherein the fertilizer is homogenous.

Aspect 10 is the fertilizer composition of any one of aspects 1 to 9, wherein the composition comprises a gel.

Aspect 11 is the fertilizer composition of any one of aspects 1 to 10, wherein the composition comprises a dried gel.

Aspect 12 is the fertilizer composition of any one of aspects 1 to 11, wherein at least a portion of the ammonium sulfate and/or calcium nitrate is encapsulated by the calcium ammonium phosphate.

Aspect 13 is the fertilizer composition of any one of aspects 1 to 12, wherein the fertilizer composition is a granular fertilizer.

Aspect 14 is the fertilizer composition of any one of aspects 1 to 13, wherein the composition does not comprise at least one of urea or a polymer.

Aspect 15 is a method of producing the fertilizer composition of any one of aspects 1 to 14, the method comprising the steps of: (a) contacting calcium phosphate with nitric acid and a source of ammonia to generate a first reaction product comprising: calcium ammonium phosphate and ammonium nitrate; and (b) contacting the first reaction product with calcium sulfate to generate a second reaction product comprising: calcium nitrate and ammonium sulfate, wherein the second reaction product further comprises calcium ammonium phosphate generated in step (a).

Aspect 16 is the method of aspect 15, wherein step (a) comprises: contacting calcium phosphate with nitric acid to generate an initial reaction product comprising: calcium nitrate and phosphoric acid; and contacting the initial reaction product with a source of ammonia to generate the first reaction product.

Aspect 17 is the method of any one of aspects 15 to 16, further comprising drying the second reaction product to form a solid fertilizer composition.

Aspect 18 is the method of any one of aspects 15 to 17, wherein the calcium sulfate comprises red gypsum and/or waste gypsum from production of phosphoric acid and/or wherein the source of ammonia is ammonium hydroxide and/or ammonia.

Aspect 19 is the method of any one of aspects 15 to 18, wherein steps (a) and/or (b) occurs at 20 to 150° C. and/or for 30 minutes to 12 hours.

Aspect 20 is a method of fertilizing, the method comprising contacting a plant, a soil, water, or a combination thereof with the fertilizer compositions of any one of aspects 1 to 14.

The term “fertilizer” is defined as a material applied to soils or to plant tissues to supply one or more plant nutrients essential or beneficial to the growth of plants and/or stimulants or enhancers to increase or enhance plant growth.

The term “granule” can include a solid material. A granule can have a variety of different shapes, non-limiting examples of which include a spherical, a puck, an oval, a rod, an oblong, or a random shape.

The term “particle” can include a solid material less than a millimeter in its largest dimension.

The terms “particulate” or “powder” can include a plurality of particles.

The terms “about” or “approximately” as used herein are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The use of the word “a” or “an” when used in conjunction with the term “comprising” may mean “one,” but it is also consistent with the meaning of “one or more,” “at least one,” and “one or more than one.”

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The compositions and methods for their use can “comprise,” “consist essentially of,” or “consist of” any of the ingredients or steps disclosed throughout the specification. Compositions and methods “consisting essentially of” any of the ingredients or steps disclosed limits the scope of the claim to the specified materials or steps which do not materially affect the basic and novel characteristic of the claimed invention.

It is contemplated that any embodiment discussed in this specification can be implemented with respect to any method or composition of the invention, and vice versa. Furthermore, compositions of the invention can be used to achieve methods of the invention.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1: a schematic of a system and method for producing a fertilizer according to a non-limiting example of a system and method disclosed herein.

FIG. 2: a schematic of a system and method for producing a fertilizer according to another non-limiting example of a system and method disclosed herein.

### BRIEF DESCRIPTION OF THE INVENTION

Certain aspects of the present disclosure provide benefits over existing fertilizers, including by having slow-release characteristics for nutrients comprising the fertilizer. Certain aspects provided herein allow for the fertilizer to slowly release nutrients into the soil over a period of time, such as throughout a growing cycle for a plant. This capability can be achieved, in some aspects, without the use of binders, inhibitors, or other interventions that add compounds beyond the fertilizer's nutrients. In some embodiments, the fertilizer comprises a double salt, such as a metal ammonium phosphate, such as calcium ammonium phosphate (CaNH₄PO₄), and water soluble nutrients, such as ammonium sulfate ((NH₄)₂SO₄), and calcium nitrate (Ca(NO₃)₂), which may be one composition and/or one homogenous mixture. The metal ammonium phosphate compound may act as a binder for the other components in the fertilizer.

### I. Fertilizer

Certain embodiments herein concern a complex fertilizer comprising: a double salt, such as a metal ammonium phosphate, which may comprise CaNH₄PO₄. Certain aspects involve synthesis of the nutrient complex using natural sources of ingredients of the fertilizer, such as Ca₃(PO₄)₂, HNO₃, Ca(NO₃)₂, (NH₄)₃PO₄, NH₄NO₃, H₃PO₄, CaSO₄, (NH₄)₂SO₄, NH₃, and NH₄OH. In some aspects, the complex fertilizer is a mixture that is a homogeneous mixture

The fertilizer, which may be a fertilizer granule, can contain a mixture containing calcium (Ca), phosphorus (P), nitrogen (N) present as ammonium and/or nitrate, sulfur(S) present as sulfate. The ratio of elements present in the fertilizer may be tailored to specific applications.

At least a portion of Ca can be present as calcium ammonium phosphate and/or calcium nitrate. In some aspects, at least 90 wt. %, or at least 95 wt. %, or 90 wt. % to 100 wt. %, or at least any one of, at most any one of, equal to any one of, or between any two of 90, 91, 92, 93, 94, 95, 96, 97, 98, 99, 99.5, and 100 wt. % of the Ca in the mixture can be present as calcium ammonium phosphate and/or calcium nitrate, based on the total weight of Ca in the mixture. In some embodiments, at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. % of the Ca in the mixture can be present as calcium ammonium phosphate. In some embodiments, at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. % of the Ca in the mixture can be present as calcium nitrate.

In some aspects, the complex fertilizer can contain i) (NH₄)₂SO₄ in an amount providing at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. % based on the total weight of the mixture and/or the fertilizer granule; ii) Ca(NO₃)₂ in an amount providing at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, and 99 wt. % based on the total weight of the mixture and/or the fertilizer granule; and iii) CaNH₄PO₄ in an amount providing at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. % based on the total weight of the mixture and/or the fertilizer granule.

In some aspects, the homogenous mixture comprises Ca, N, P, and/or S wherein i) the Ca content of the homogenous mixture can be at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. %, ii) the N content of the homogenous mixture can be at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. %, iii) the P content of the homogenous mixture can be at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. %, and iv) the S content of the homogenous mixture can be at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. %, based on the total weight of the mixture and/or fertilizer.

The Ca, N, P, and/or S can be present as and/or sourced as a water soluble compound or a water insoluble compound. In some instances, the Ca, N, P, and/or S can be present as a salt. In some aspects, the Ca, N, P, and/or S can be present as a water soluble salt. In some instances, the water soluble Ca and N salt can be Ca(NO₃)₂. In some instances, the water soluble N and S salt can be (NH₄)₂SO₄. The Ca, N, P, and/or S salt can be in a non-hydrate and/or one or more hydrate form.

In certain aspects, the calcium phosphate is sourced from or is comprised in calcium phosphate rock. In certain aspects, the calcium sulfate is gypsum. In certain aspects, the gypsum is and/or is sourced from or is comprised in red gypsum or waste gypsum.

Moisture content of the dried fertilizer can be less than 1 wt. %, such as 0.1 wt. % to 0.9 wt. %, or any one of or between any two of 0.1, 0.2, 0.3, 0.4, 0.5, 0.6, 0.7, 0.8, 0.9, or 1 wt. %, or any range thereof, based on the weight of the fertilizer granule. As a non-limiting example, the moisture content can be measured by drying the sample at 50° C. for 25 min and measuring the amount of mass lost by the fertilizer after being dried.

The fertilizer can be of any suitable shape. Non-limiting shapes include spherical, cuboidal, cylindrical, puck shape, oval, and oblong shapes. In some aspects, the fertilizer granule can be of cylindrical shape with a circular, elliptical, ovular, triangular, square, rectangular, pentagonal, or hexagonal cross section, although cylindrical shaped core having a cross-section of other shapes can also be made. In some aspects, the fertilizer granule at its widest dimension can be 0.5 mm to 6 mm, or 0.5 mm to 5 mm, preferably 1 mm to 4 mm, or at least any one of, at most any one of, equal to any one of, or between any two of 0.5 mm, 1 mm, 1.5 mm, 2 mm, 2.5 mm, 3 mm, 3.5 mm, 4 mm, 4.5 mm, 5 mm, 5.5 mm, and 6 mm. In some particular aspects, the fertilizer granule can have a substantially spherical shape with an average diameter 0.5 mm to 6 mm, or 0.5 mm to 5 mm, preferably 1 mm to 4 mm, or at least any one of, at most any one of, equal to any one of, or between any two of 0.5 mm, 1 mm, 1.5 mm, 2 mm, 2.5 mm, 3 mm, 3.5 mm, 4 mm, 4.5 mm, 5 mm, 5.5 mm, and 6 mm.

The fertilizer can be water and/or soil dispersible. In some aspects, a fertilizer granule having a size of 2 mm to 4 mm prior to adding to water, can disintegrate into particles having sizes less than 1 mm, less than 0.9 mm, less than 0.8 mm, less than 0.7 mm, less than 0.6 mm, less than 0.5 mm, less than 0.4 mm, or less than 0.3 mm, within 1 minute of adding the granule to water at a pH 7, under stirring at a rate 90 rpm to 110 rpm, at an ambient temperature.

The mixture can have a compositional make-up that is substantially homogeneous. In some instances, a compositional make-up for a 1 mm×1 mm×1 mm cube at any position of the mixture can be similar (within ±20%, or ±10%, or ±5%, or ±3%, ±2%, or ±1%, or ±0.5%) to that of a 1 mm×1 mm×1 mm cube at any other position of the mixture.

In some aspects, the fertilizer granule can contain an homogeneous mixture. The homogeneous mixture can have compositions as described above. In some instances, the homogenous mixture can have an optional coating on the outer surface of the homogenous mixture. In some instances, the CaNH₄PO₄ can act as a binder in the fertilizer. In some instances the CaNH₄PO₄ is the only binder in the fertilizer. In some instances, the CaNH₄PO₄ forms an amorphous phase, a continuous phase, and/or encapsulate other ingredients in the fertilizer. In some instances, the fertilizer comprises a matrix of CaNH₄PO₄ that at least partially surrounds and/or encapsulates at least a portion of the calcium nitrate and/or ammonium sulfate. In some instances, the fertilizer comprises particles of the CaNH₄PO₄ and/or of calcium nitrate and/or ammonium sulfate.

In some aspects, additional fertilizer substances can be included or excluded in the fertilizer. If included, additional fertilizers can be chosen based on the particular needs of certain types of soil, climate, or other growing conditions to maximize the efficacy of the fertilizer in enhancing plant growth and crop yield. Additional additives may also be included or excluded in the fertilizer. Non-limiting examples of additives that can be included or excluded from the fertilizer of the present invention include additional nitrogen nutrients, additional phosphorus nutrients, additional potassium nutrients, additional micronutrients, and/or additional secondary nutrients. The micronutrient can be copper, iron, chloride, manganese, molybdenum, or nickel, or any combinations thereof. The nitrogen nutrient can be urea, ammonium nitrate, ammonium sulfate, diammonium phosphate, monoammonium phosphate, urea-formaldehyde, ammonium chloride, and potassium nitrate. In some aspects, the additional secondary nutrients may include lime and/or superphosphate. In some instances, the additional fertilizer substances and/or the additional additives are contained in the optional coating of the fertilizer.

In some instances, the inhibitors include nitrification inhibitors and/or urease inhibitors. Suitable nitrification inhibitors include, but are not limited to, 3,4-dimethylpyrazole phosphate (DMPP), dicyandiamide (DCD), thiourea (TU), 2-chloro-6-(trichloromethyl)-pyridine (Nitrapyrin), 5-ethoxy-3-trichloromethyl-1,2,4-thiadiazol, which is sold under the tradename Terrazole®, by OHP Inc., USA, 2-amino 4-chloro 6-methyl pyrimidine (AM), 2-mercaptobenzothiazole (MBT), or 2-sulfanilamidothiazole (ST), and any combination thereof. In one aspect, a nitrification inhibitor can comprise DMPP, DCD, TU, nitrapyrin, 5-ethoxy-3-trichloromethyl-1,2,4-thiadiazol, AM, MBT, or ST, or a combination thereof. In some embodiments, a fertilizer composition can comprise NBTPT, DMPP, TU, DCD, PPDA, nitrapyrin, 5-ethoxy-3-trichloromethyl-1,2,4-thiadiazol, AM, MBT, ST, or a combination thereof.

In some instances, a binder includes a phosphate, a polyphosphate, a biodegradable polymer, or a wax, or a combination thereof. Suitable waxes include, but are not limited to, vegetable waxes, high melt waxes, ethylene bis(stearamide) wax, paraffin waxes, polyethylene based waxes, and olefin waxes. Suitable phosphates include, but are not limited to, diammonium phosphate, and monoammonium phosphate. Suitable polyphosphates include, but are not limited to, ammonium polyphosphate. Suitable biodegradable polymers include, but are not limited to, polyacrylamide, polyacrylic acid, polyacrylonitrile, biodegradable polylactic acid and other biodegradable polymeric material such as polylactic acid, poly(3-hydroxypropionic acid), polyvinyl alcohol, poly e-caprolactone, poly L-lactide, poly butylene succinate, and biodegradable starch based polymers. The binder can include plaster of Paris, flour, starch, gluten, kaolin, bentonite, colloidal silica, or combinations thereof. Suitable flours include, but are not limited to, rice flour, wheat flour, and bleached wheat flour. Suitable starches include, but are not limited to, dextrin modified starches.

In some instances, the pH buffers include MgO, KH₂PO₄, NaHCO₃, chalk powder, aluminum, magnesium hydroxide, aluminum hydroxide/magnesium hydroxide co-precipitate, aluminum hydroxide/sodium bicarbonate co-precipitate, calcium acetate, calcium bicarbonate, calcium borate, calcium carbonate, calcium bicarbonate, calcium citrate, calcium gluconate, calcium hydroxide, dibasic sodium phosphate, dipotassium hydrogen phosphate, dipotassium phosphate, disodium hydrogen phosphate, magnesium acetate, magnesium borate, magnesium bicarbonate, magnesium carbonate, magnesium hydroxide, magnesium lactate, magnesium oxide, magnesium phosphate, magnesium silicate, magnesium succinate, magnesium tartrate, potassium acetate, potassium carbonate, potassium bicarbonate, potassium borate, potassium citrate, potassium metaphosphate, potassium phthalate, potassium phosphate, potassium polyphosphate, potassium pyrophosphate, potassium succinate, potassium tartrate, sodium acetate, sodium bicarbonate, sodium borate, sodium carbonate, sodium citrate, sodium gluconate, sodium hydrogen phosphate, sodium hydroxide, sodium lactate, sodium phthalate, sodium phosphate, sodium polyphosphate, sodium pyrophosphate, sodium tartrate, sodium tripolyphosphate, synthetic hydrotalcite, tetrapotassium pyrophosphate, tetrasodium pyrophosphate, tripotassium phosphate, trisodium phosphate, and trometamol, and combinations thereof.

The fertilizer described herein can be comprised in a composition useful for application to soil. In some aspects, in addition to the fertilizer described herein, the composition may include other fertilizer compounds, micronutrients, primary nutrients, urea, additional nitrogen nutrients, insecticides, herbicides, or fungicides, or combinations thereof. The fertilizer described herein can also be included in a blended composition comprising other fertilizers. The other fertilizer can be urea, monoammonium phosphate (MAP), diammonium phosphate (DAP), muriate of potash (MOP), monopotassium phosphate (MKP), triple super phosphate (TSP), rock phosphate, single super phosphate (SSP), ammonium sulfate, and the like.

A fertilizer formed into a granule can have desirable physical properties such as desired levels of abrasion resistance, granule strength, pelletizability, hygroscopicity, granule shape, and size distribution. In some aspects, The fertilizer granule can have a crush strength above 1.5 kgf, such as above 1.8 kgf, such as 2 kgf to 6 kgf, or at least any one of, equal to any one of, or between any two of 2, 2.5, 3, 3.5, 4, 4.5, 5, 5.5, and 6 kgf. Bulk density of the fertilizer granules can be 1 g/cc to 1.2 g/cc, or at least any one of, at most any one of, equal to any one of, or between any two of 1, 1.02, 1.04, 1.06, 1.08, 1.1, 1.12, 1.14, 1.16, 1.18, and 1.2 g/cc. In some aspects, 10 mg or more, such as 10 mg to 40 mg, or at least any one of, at most any one of, equal to any one of, or between any two of 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40 mg of the fertilizer granule can dissolve in 1 ml of water at a pH 7, under stirring at a rate 90 to 110 rpm, and at an ambient temperature, within 5 minutes of adding 100 mg of the fertilizer granules to the water. In some aspects, the fertilizer granule is capable of losing less than 0.13 wt. %, such as 0.02% to 0.12 wt. %, or at most any one of, equal to any one of, or between any two of 0.02, 0.03, 0.04, 0.05, 0.06, 0.07, 0.08, 0.09, 0.1, 0.11, and 0.12 wt. % in an attrition loss test. Attrition loss can be measured using the following attrition loss test.

Attrition loss test: A plurality of sieved fertilizer granules with individual size 2 to 4 mm, and total volume 100 cm³ is weighed (W1) and is placed into the test drum along with the 50 stainless steel balls having a total weight of 100 μm. The drum is closed and rotated for 10 min at 30 rpm. Then, the steel balls are separated from the sample and the material is screened over 2 mm sieve using a sieve shaker. The total weight of the granules over 2 mm are then re-weighed (W2). Results are calculated in terms of % weight loss using the formula:

$$Weight loss due to attrition ( wt . \% ) = \frac{weight of sample remained on 2 mm sieve ( ( W 2 ) )}{intial weight of the sample ( W 1 )} \times 100$$

### II. Method of Making a Fertilizer

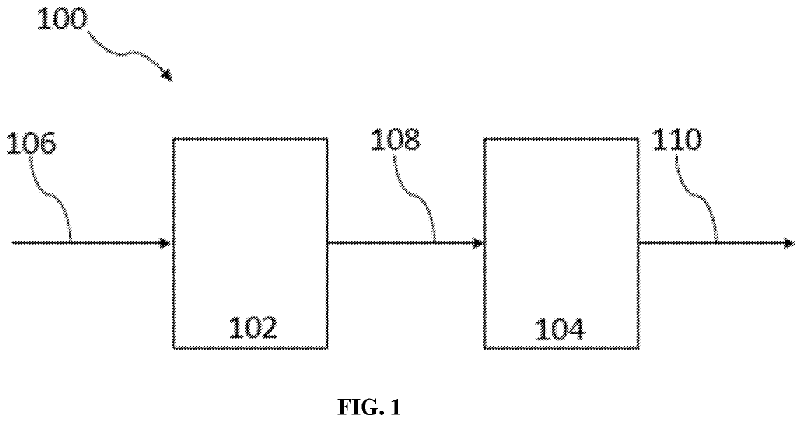

Referring to FIG. 1, a schematic of a system and method for making a fertilizer according to one example of the present invention is described. The system 100 can include a granulator 102 and a dryer 104. A feed mixture 106 can be granulated in the granulator 102 in the presence or absence of water to form a wet granulated mixture 108. The water, if present, can be provided with the feed mixture 106, and/or can be added separately to the granulator 102. The wet granulated mixture 108 can be dried in the dryer 104 to obtain dry granulated mixture 110 containing the fertilizer.

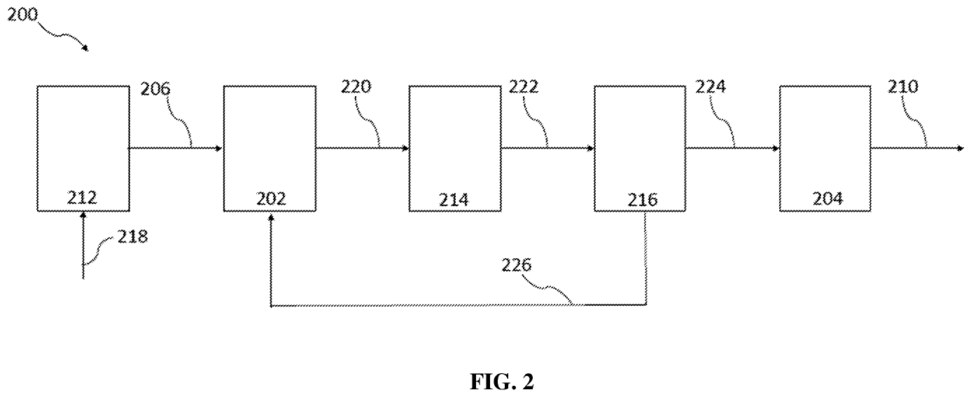

Referring to FIG. 2, a schematic of a system and method for making a fertilizer according to another example of the present invention is described. The system 200 can include a mixer/reactor 212, though the mixer and the reactor can be two, three, four, or more components, such as two reactors and a mixer or a reactor and a mixer. The system 200 can include a granulator 202, a spheronizer 214, one or more size screens 216, and a dryer 204, or any combination thereof. The feed mixture ingredients 218, separately and/or at any possible combination can be added to the mixer/reactor 212. In the mixer/reactor 212, the feed ingredients can be reacted and/or mixed to form the feed mixture 206. Feed mixture 206 can be granulated in the granulator 202 in presence or absence of additional water to form a wet granulated mixture 220. Granules of the wet granulated mixture 220 can be spheronized in the spheronizer 214 to form a wet granulated mixture 222 containing substantially spherical granules. The wet granulated mixture 222 can be passed through one or more size screens 216 to separate granules having a size smaller or bigger than a desired size from the wet granulated mixture 222 and obtain a wet granulated mixture 224 containing granules of desired size. At least a portion of the granules separated 226 from the granulation mixture 224 containing granules of desired size can be recycled to the granulator 202. The wet granulated mixture 224 containing granules of desired size can be dried in the dryer 204 to obtain dry granulated mixture 210 containing the fertilizer granule. In some aspects, the mixer/reactor 212 can contain a ribbon mixer.

The feed mixture ingredients 218 can include i) a Ca source, e.g., calcium phosphate and/or calcium sulphate, ii) a N source, e.g., nitric acid, NH₄⁺, NH₄OH, and/or NH₃, iii) a P source, e.g., calcium phosphate, and iv) a S source, e.g., calcium sulphate. In some instances, a mixture ingredient provides more than one of Ca, N, P, and/or S. In some instances, a mixture ingredient provides additional nutrients and/or micronutrients, such as K, Mg, Fe, and/or Si. In certain aspects, one or more ingredients can be added as a water solution. In some instances, the mixture ingredients are provided as a powder. In some instances, one or more ingredients can be added as a gas. In some instances, the NH₃ is provided at a pressure above 1 bar, such as at, or between, or of any range of 1.2, 1.3, 1.4, 1.5, 2, 2.5, 3, 3.5, 4, 4.5, 5, 5.5, 6, 6.5, 7, 7.5, 8, 9, 10, 15, 20, 25, 30, 35, and 40 bar. In some instances, a portion of the mixture of ingredients is provided as a powder.

The feed mixture 106, 206 can contain Ca, N, P, and/or S. In some aspects, the feed mixture 106, 206 can contain CaNH₄PO₄, Ca₃(PO₄)₂, HNO₃, Ca(NO₃)₂, (NH₄)₃PO₄, NH₄NO₃, H₃PO₄, CaSO₄, (NH₄)₂SO₄, NH₃, and/or NH₄OH.

Water can be added to the feed mixture in the mixer/reactor 212 and/or in the granulator 102, 202. In certain aspects, 5 μm to 20 μm, or at least any one of, at most any one of, equal to any one of, or between any two 5, 6, 7, 8, 9, 10, 11, 12, 13, 14, 15, 16, 17, 18, 19, and 20 μm of water in total (e.g., added with one or more feed mixture ingredients and/or separately) can be added to the feed mixture, per 100 μm of feed mixture.

In some aspects, the granulator 102, 202 can be a drum granulator, pugmill granulator, pan granulator, solid mixer, abrasion drum, extruder, high-shear mixer granulator, roller granulator, mycromix, or a round bottom flask. In the granulator 102, 202 the feed mixture 106, 206 can be granulated by agglomeration, spray granulation, compaction, slurry granulation and/or high-shear mixer granulation. In some particular aspect, the feed mixture 106, 206 can be granulated in the granulator 102, 202 by compaction. In some aspects, the granulator 102, 202 can contain at least two rollers and compaction granulation can include compressing the feed mixture using the at least two rollers. In some aspects, the two rollers can be moved in counter current direction during compaction. In some aspects, the feed mixture can be compressed into shaped pellets, such as cylindrical pellets, by the at least two rollers. In some aspects, a surface of one roller can have desired holes to compress the feed mixture into the holes, and the surface of the other roller can push the feed mixture into the holes. Pressure during granulation, e.g. compaction granulation can be 1 bar to 40 bar, or at least any one of, at most any one of, equal to any one of, or between any two 1, 2, 3, 4, 5, 10, 15, 20, 25, 30, 35, and 40 bar. In certain aspects, the feed mixture can be granulated in the granulator 102, 202 at ambient temperature to 50° C., or at least any one of, at most any one of, equal to any one of, or between any two of −20, −15, −10, 0, 5, 10, 15, 20, 25, 30, 35, 40, 45 and 50° C.

In some aspects, reacting of the feed mixture ingredients, mixing, and granulating the feed mixture can be performed in different containers, e.g., the mixer/reactor 212 and the granulator 202 can be different containers. In some aspects, reacting of the feed mixture ingredients, mixing, and granulating the feed mixture can be performed in the same container, e.g., the mixer/reactor 212 and the granulator 202 can be the same container (not shown). In some aspects, the mixer/reactor 212 and the granulator 202 can be more than two containers. As non-limiting examples, in some instances, the CaNH₄PO₄ and Ca(NO₃)₂ are formed in two different containers. In some instances, the CaNH₄PO₄ and Ca(NO₃)₂ are formed in one container. In some instances, the CaNH₄PO₄ and H₃PO₄ are formed in two different containers. In some instances, the CaNH₄PO₄ and H₃PO₄ are formed in one container. In some instances, the CaNH₄PO₄ and Ca(NO₃)₂ are formed in two different containers and the CaNH₄PO₄ and H₃PO₄ are formed in one container. In some instances, the CaNH₄PO₄ and Ca(NO₃)₂ are formed in two different containers and the CaNH₄PO₄ and H₃PO₄ are formed in two different containers. In some instances, the CaNH₄PO₄, Ca(NO₃)₂, and H₃PO₄ are formed in one container. In some instances, the CaNH₄PO₄, Ca(NO₃)₂, and H₃PO₄ are each formed in different containers.

In some aspects, the CaNH₄PO₄, Ca(NO₃)₂, (NH₄)₃PO₄, NH₄NO₃, H₃PO₄, and/or (NH₄)₂SO₄ are formed at a temperature of at least, at most, equal to, or between any two of 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, or 150° C., such as between 2° and 80° C. or between 10° and 150° C. or between 75 and 150° C. or between 55 to 75° C. or between 2° and 150° C.

In some instances, the fertilizer can be extruded before drying. The extruder can extrude the fertilizer at pressures at least, at most, equal to, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40 bar. The extruder can extrude the fertilizer at temperatures at least, at most, equal to, or between any two of −20, −15, −10, 0, 5, 10, 15, 20, 25, 30, 35, 40, 45 and 50° C. The extrudate can be sliced or divided before drying, such as by a die.

In certain aspects, the desired size of a final fertilizer product, such as a granule, can be 0.5 to 5 mm, or 1 to 4 mm, and having a size lower than 0.5 mm or 1 mm, and/or having a size bigger than 4 mm or 5 mm can be separated from the wet granulated mixture 222 in the one or more size screens 216. In certain aspects, the wet granulated mixture can be rounded and/or spheronized in a spheronizer. In some instances, the wet granulated mixture is contacted with a spheronizer for at least any one of, at most any one of, equal to any one of, or between any two of 5, 10, 15, 20, 25, 30, 35, 40, 50, or 60 seconds. The spheronizer in some instances has a rotating or rotatable disk capable of rotating at least any one of, at most any one of, equal to any one of, or between any two of 200, 500, 1000, 1500, 2000, 2500, 3000, 3500, 4000, 4500, 5000 rpm. In certain aspects, the wet granulated mixture can be dried in the dryer 104, 204 at a temperature 40° C. to 150° C., or at least any one of, at most any one of, equal to any one of, or between any two of 40, 45, 50, 55, 60, 65, 70, 75, 80, 85, 90, 95, 100, 105, 110, 115, 120, 125, 130, 135, 140, 145, 150° C. In some aspects, the dryer 104, 204 can be a fluid bed dryer, drum dryer, or flash dryer. In some aspects, the wet granulated mixture can be dried in the dryer 104, 204 with an hot air flow having a flow rate of at least any one of, at most any one of, equal to any one of, or between any two of 100, 150, 200, 250, 300, 350, 400, 450, and 500 m³/hr and/or a rotation of at least any one of, at most any one of, equal to any one of, or between any two of 5, 10, 15, 20, 25, 30, 35, 40, 45, and 50 rpm.

### III. Methods of Using the Fertilizer

The fertilizer, including fertilizer granules, compositions containing the fertilizer, and fertilizer blends containing the fertilizer of the present disclosure can be used in methods of increasing the amount of one or more plant nutrients in soil and of enhancing plant growth. Such methods can include applying to the soil an effective amount of a composition and/or blend containing the fertilizer of the present invention. The method may include increasing the growth and yield of crops, trees, ornamentals, etc., such as, for example, palm, coconut, rice, wheat, corn, barley, oats, and/or soybeans. The method can include applying the fertilizer blend of the present invention to at least one of a soil, an organism, a liquid carrier, a liquid solvent, etc. The composition(s) and/or fertilizer blends(s) containing the fertilizer can be applied to plants and/or soil as a top dressing fertilizer, basal fertilizer, and/or through any suitable method of application.

Non-limiting examples of plants that can benefit from the fertilizer of the present invention include vines, trees, shrubs, stalked plants, ferns, etc. The plants may include orchard crops, vines, ornamental plants, food crops, timber, and harvested plants. The plants may include Gymnosperms, Angiosperms, and/or Pteridophytes.

The effectiveness of compositions comprising the fertilizer of the present invention can be ascertained by measuring the amount of phosphorus and optionally other nutrients in the soil at various times after applying the fertilizer composition to the soil. It is understood that different soils have different characteristics, which can affect the stability of the nutrients in the soil. The effectiveness of a fertilizer composition can also be directly compared to other fertilizer compositions by doing a side-by-side comparison in the same soil under the same conditions.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### I. Example 1—Preparation of a Fertilizer

100 g of calcium phosphate can be added to 164 g nitric acid and stirred at 25° C. for 2 hours to dissolve the calcium phosphate in the nitric acid. The solution can then be fed ammonia gas with flow rate of 15 cc/min for 1 hour to form a first gel. CaSO₄ gel can be prepared and added to the first gel to form a mixture. The mixture can then be stirred for an hour and then dried at 120° C. for 8 hours. The produced material can be grounded to particles with a size within 1-2 mm.

The fertilizer produced can contain 15.6% N, P in an amount equivalent to 16% P₂O₅, 17.9% Ca, and 7% S by weight.

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

1. A fertilizer composition comprising calcium ammonium phosphate (CaNH₄PO₄), calcium nitrate (Ca(NO₃)₂), and ammonium sulfate ((NH₄)₂SO₄) wherein:
at least a portion of the ammonium sulfate and/or calcium nitrate is absorbed on the surface of the calcium ammonium phosphate; and/or
at least a portion of the ammonium sulfate and/or calcium nitrate is encapsulated by the calcium ammonium phosphate.

2. The fertilizer composition of claim 1, wherein the composition comprises 12 to 19 wt. % nitrogen (N), phosphorous (P) in an amount equivalent to 12 to 19 wt. % P₂O₅, 14 to 20 wt. % calcium (Ca), and 5 to 10 wt. % sulfur(S).

3. The fertilizer composition of claim 1, wherein the composition further comprises phosphoric acid (H₃PO₄), ammonium phosphate ((NH₄)₃PO₄), ammonium hydroxide (NH₄OH), and/or ammonium nitrate (NH₄NO₃).

4. The fertilizer composition of claim 1, wherein the composition further comprises calcium sulfate (CaSO₄), a calcium phosphate (Ca₃(PO₄)₂), nitric acid (HNO₃), and/or ammonia (NH₃).

5. The fertilizer composition of claim 4, wherein the composition comprises calcium sulfate comprised in waste gypsum and/or a recycled gypsum.

6. The fertilizer composition of claim 1, wherein the composition does not comprise a binding agent separate from the calcium ammonium phosphate.

7. The fertilizer composition of claim 1, wherein at least a portion of the ammonium sulfate and/or calcium nitrate is absorbed on the surface of the calcium ammonium phosphate.

8. The fertilizer composition of claim 1, wherein the fertilizer composition further comprises a potassium source.

9. The fertilizer composition of claim 1, wherein the fertilizer is homogenous.

10. The fertilizer composition of claim 1, wherein the composition comprises a gel.

11. The fertilizer composition of claim 1, wherein the composition comprises a dried gel.

12. The fertilizer composition of claim 1, wherein at least a portion of the ammonium sulfate and/or calcium nitrate is encapsulated by the calcium ammonium phosphate.

13. The fertilizer composition of claim 1, wherein the fertilizer composition is a granular fertilizer.

14. The fertilizer composition of claim 1, wherein the composition does not comprise at least one of urea or a polymer.

15. A method of producing the fertilizer composition of claim 1, the method comprising the steps of:
(a) contacting calcium phosphate with nitric acid and a source of ammonia to generate a first reaction product comprising:
calcium ammonium phosphate and ammonium nitrate; and
(b) contacting the first reaction product with calcium sulfate to generate a second reaction product comprising:
calcium nitrate and ammonium sulfate,
wherein the second reaction product further comprises calcium ammonium phosphate generated in step (a).

16. The method of claim 15, wherein step (a) comprises:
contacting calcium phosphate with nitric acid to generate an initial reaction product comprising:
calcium nitrate and phosphoric acid; and
contacting the initial reaction product with a source of ammonia to generate the first reaction product.

17. The method of claim 15, further comprising drying the second reaction product to form a solid fertilizer composition.

18. The method of claim 15, wherein the calcium sulfate comprises red gypsum and/or waste gypsum from production of phosphoric acid and/or wherein the source of ammonia is ammonium hydroxide and/or ammonia.

19. The method of claim 15, wherein steps (a) and/or (b) occurs at 20 to 150° C. and/or for 30 minutes to 12 hours.

20. A method of fertilizing, the method comprising contacting a plant, a soil, water, or a combination thereof with the fertilizer composition of claim 1.
